(19) United States
(12) Patent Application Publication
(10) Pub. No.: US 2026/0034598 A1
(43) Pub. Date: Feb. 5, 2026

(54) Method of Forming Solder Contact Pins

(71) Applicant: Pac Tech - Packaging Technologies GmbH, Nauen (DE)

(72) Inventors: Matthias Fettke, Berlin (DE); Andrej Kolbasow, Berlin (DE)

(21) Appl. No.: 18/990,155

(22) Filed: Dec. 20, 2024

(30) Foreign Application Priority Data
Jul. 31, 2024 (DE) 102024121793.6

(51) Int. Cl. B23K 3/06

(52) U.S. Cl. CPC B23K 3/0623

(57) ABSTRACT

A method of forming a plurality of solder contact pins on a contact pad layout of a substrate including the steps of arranging a plurality of first solder balls at an arranging layout of a transporting tool, the arranging layout of the transporting tool corresponding to the contact pad layout of the substrate, placing the transporting tool opposite the substrate such that the plurality of first solder balls is associated with the plurality of contact pads, melting the plurality of first solder balls and releasing the plurality of first solder balls to the plurality of contact pads so as to form a plurality of solder bumps arranging a plurality of second solder balls at the arranging positions and releasing the plurality of second solder balls from the transporting tool so as to form a plurality of monolithic solder contact pins on the plurality of contact pads.

### BACKGROUND OF THE INVENTION

### Field of the Invention

The present disclosure relates to a method of forming a plurality of solder contact pins on a contact pad layout of a substrate, said contact pad layout comprising a plurality of contact pads.

Conventionally, a soldering point in the form of a solder contact pin is formed on a substrate, by placing a solder contact pin having a specific geometry, i.e. having a specific height and diameter, on the substrate. In particular, the solder contacts pins are placed on the substrate using masks having openings corresponding to the shape of the solder contact pins and using vibration methods for aligning the solder contact pins in the openings and on the substrate. Subsequently, the solder contact pins are connected to the substrate via electrically conductive adhesives or soldering material, preferably having a lower melting point than the solder contact pins, using thermal convection or heat conduction processes, for example a reflowing furnace.

In this way, solder contact pins of a size required for a specific application, e.g. the connection of a chip or another substrate, can be placed on and attached to a substrate. However, disadvantages are that, depending on the application, solder contact pins of certain sizes as well as a holder and a mask of the corresponding size must be used to feed and place the solder contact pins on the substrate. If another substrate is to be connected to the solder contact pins, the another substrate must be provided with electrically conductive adhesives or soldering material with a lower melting point. Furthermore, the use of different materials for the substrate, contact medium and contact pin material can lead to interface problems.

### Description of Related Art

Document DE 198 38 532 A1 discloses a method and device for placing and melting a plurality of solder balls to a substrate using a template device comprising a perforated disk. Solder balls are either provided in an interior space of the device and discharged through template openings of the device using an overpressure (FIGS. 2 to 6) or via sucking solder balls from outside of the device to template openings using an negative pressure in an interior space of the device and then discharging the solder balls on the substrate by creating an overpressure in the interior space (FIGS. 8 to 11). The solder balls placed on the substrate are melted to the substrate by applying laser energy onto them.

Document DE 197 39 481 A1 discloses a method for positioning a plurality of solder balls on a substrate and for melting them onto the substrate by means of a laser. Specifically, the method of DE 197 39 481 A1 comprises the steps of sucking on a plurality of solder balls from a solder ball reservoir through a plurality of passages provided in a solder ball fixing device and having cross-sectional areas which are smaller than those of the solder balls, in such a way that respective solder balls are fixed to the passages, moving the solder ball fixing device to the substrate and placing the solder balls onto a surface of the substrate, and melting the solder balls by conducting laser pulses through the passages. In particular, a negative pressure produced in a cavity of the solder ball fixing device for sucking and fixing the solder balls to the passages is realized by means of a vacuum pump. When the solder balls have been sucked to the passages it can be checked, for example by means of pressurized air and/or a laser beam, whether all solder balls are fixed to the passages. Further, the laser pulses are generated by a laser pulse generation means being capable of conducting laser pulses through individual glass fibres provided for each solder ball.

Thus, using the methods as disclosed in DE 198 38 532 A1 or DE 197 39 481 A1, a plurality of solder balls can be applied to a substrate in a timesaving manner and without the use of a flux. However, the methods as known from the prior art are limited with respect to the generation of soldering points having different sizes, in particular heights, required for specific bonding applications, for example connecting specific electronic components, e.g. a chip, or another substrate.

### SUMMARY

It is an object of the present disclosure to provide a method of forming a plurality of solder contact pins on a contact pad layout of a substrate, wherein the method is straight forward and the solder contact pins are variable in height. Further, it is an object to provide a solder ball placing apparatus for carrying out such a method.

This object is solved by the method according to independent claim 1 and independent claim 9. Preferred embodiments are subject of the dependent claims.

The present disclosure discloses a method of forming a plurality of solder contact pins on a contact pad layout of a substrate, said contact pad layout comprising a plurality of contact pads, which may comprise the steps of: a) arranging a plurality of first solder balls at a plurality of arranging positions of an arranging layout of a transporting tool, said arranging layout of the transporting tool corresponding to the contact pad layout of the substrate, b) placing the transporting tool opposite the substrate such that the plurality of first solder balls is associated with the plurality of contact pads, c) placing the plurality of first solder balls onto the plurality of contact pads, d) melting the plurality of first solder balls and releasing the plurality of first solder balls from the transporting tool to the plurality of contact pads so as to form a plurality of solder bumps on the plurality of contact pads, e) withdrawing the transporting tool from the substrate, f) arranging a plurality of second solder balls at the arranging positions of the arranging layout of the transporting tool, g) placing the transporting tool opposite the substrate such that the plurality of second solder balls is associated with the plurality of solder bumps, h) placing the plurality of second solder balls onto the plurality of solder bumps, i) melting the plurality of second solder balls and releasing the plurality of second solder balls from the transporting tool to the plurality of solder bumps so as to form a plurality of monolithic solder contact pins, which can also be referred to as solder pillars, on the plurality of contact pads, and j) withdrawing the transporting tool from the substrate.

The arranging of the plurality of solder balls at the plurality of arranging positions of the arranging layout of the transporting tool in steps a) and f) may be carried out by picking up solder balls from a solder ball reservoir. Preferably, in order to pick up solder balls from the solder ball reservoir, the solder ball reservoir is exposed to ultrasound so as to achieve a statistically uniform distribution density of the solder balls in the reservoir on the one hand, and cause the solder balls to jump up in response to ultrasound oscillations on the other hand. Solder balls jumping against the transporting tool can be placed and held at the arranging positions e.g. by applying a negative pressure to the arranging positions.

Step d) melting of the plurality of first solder balls and releasing the plurality of first solder balls from the transporting tool to the plurality of contact pads so as to form a plurality of solder bumps on the plurality of contact pads can be carried out substantially simultaneously or in quick succession. Same considerations apply to step i) melting the plurality of second solder balls and releasing the plurality of second solder balls from the transporting tool to the plurality of solder bumps so as to form a plurality of monolithic solder contact pins on the plurality of contact pads. It is only important that after melting the first solder balls and releasing the first solder balls to the contact pads and after melting the second solder balls and releasing the second solder balls to the solder bumps substantially vertical monolithic solder contact pins are formed on the substrate.

The method described above can be used to quickly and easily form a large number of solder contact pins on a substrate. Since the solder contact pins are formed from soldering material, there is no need to use conductive adhesives or additional soldering material, for example when electrical components, e.g. a chip, or another substrate are attached to the substrate. Thus, interface problems resulting from the use of different materials for a substrate, contact medium and contact pin material can be reduced. The method described above can be carried out without the use of a flux, i.e. without applying a flux onto the contact pads on the substrate before melting the solder balls onto the contact pads.

In a further embodiment, steps f) to j) are repeatedly carried out to increase a height of the monolithic solder contact pins.

In this way, solder contact pins variable in height can easily be formed on the substrate by repeatedly carrying out steps f) to j).

In a further embodiment, the plurality of solder balls placed last on the monolithic solder contact pins have a lower melting point than the solder balls placed beneath them.

Thus, when bonding electronic components, e.g. chips, or another substrate to the substrate using thermal convection or heat conduction processes, for example a reflowing furnace, said components can be securely attached to the substrate via the solder contact pins while maintaining a stability of the solder contact pins and preventing a collapse of the solder contact pins during the attachment. Specifically, depending on the application, solder balls of different materials or solder material of different alloys can be used for each layer of solder balls in the solder contact pin.

In a further embodiment, between steps a) and b) and/or between steps f) and g) it is checked, in particular by pressure reading of a dynamic pressure at the arranging positions and/or by optically inspecting the arranging positions, whether all of the plurality of arranging positions of the arranging layout are covered with solder balls.

In this way, it can be ensured that all arranging positions of the transporting tool are covered with solder balls so that no defects occur when forming the monolithic solder contact pins. The checking thus helps to form a plurality of high-quality solder contact pins on a contact pad layout of a substrate. The checking can be carried out in any way. For example, the checking can be carried out optically, for example using a camera, or using a laser scanning the arranging positions. In case the transporting tool comprises a plurality of passages, at each end of which there is an arranging position for a solder ball, whereby the solder balls close the passages when they are arranged at the arranging positions, a dynamic pressure in each passage can be read or measured for each of the arranging positions to check whether a solder ball is arranged at a respective arranging position. Further, in the latter case, checking the coverage of the arranging positions with solder balls can be carried out by detecting a pressure within a negative pressure chamber branching into the plurality of passages leading to the arranging positions.

In a further embodiment, in step a) or f) the solder balls are arranged at the plurality of arranging positions of the arranging layout of the transporting tool by sucking.

The transporting tool may comprise a plurality of passages having cross-sectional areas, which are smaller than those of the solder balls, wherein at one end of each passage there is an arranging position for a solder ball and the other end of the passage is connected to a suction generating device. The plurality of arranging positions form the arranging layout of the transporting tool. By generating a negative pressure in the passages by means of the suction generating device, the solder balls can be sucked in so as to be fixed to the passages at the arranging positions. By deactivating the suction generating device, the negative pressure is released and the solder balls can be placed on or released to contact pads or solder bumps on the substrate. Thus, sucking is an easy way of reliably arranging the solder balls at the arranging positions of the arranging layout of the transporting tool.

In a further embodiment, in step d) or i) the solder balls are melted by applying laser energy onto them.

The laser melting allows for precise control over the melting process of the solder balls. Further, laser melting is a fast process, so that the energy required for melting the solder balls can be introduced into the solder balls in the shortest possible time, especially in the millisecond range, for example 5 ms-50 ms, so that the process speed can be kept high. Furthermore, laser melting can be easily integrated into an automated process, improving efficiency and consistency.

In a further embodiment, the method comprises the step of measuring a height of the monolithic solder contact pins.

Using the methods described above, a substrate with solder contact pins of variable height can be formed by repeatedly melting solder balls onto contact pads or solder bumps. Even if the height of the solder contact pins to be formed can generally be calculated in advance, certain applications require information about the actual height of the solder contact pins produced, so that measuring their height can increase process reliability.

In a further embodiment, the measuring of the height of the monolithic solder contact pins is carried out optically and/or by force reading.

An optical measurement of the height of the solder contact pins, e.g. using a camera or a laser, is preferred, as it can be automated, is precise and fast. Alternatively or additionally, the height of the solder contact pins may be determined by measuring or reading a contact force between the transporting tool and the solder contact pins. The contact force is correlated with an axial movement of the transporting tool towards the substrate so that upon contact of the transporting tool with the solder contact pins a resulting contact force suggests a height of the solder contact pins.

The present disclosure discloses a solder ball placing apparatus comprising a transporting tool, a laser source, a suction generating device, and a controller, which may be configured to control the transporting tool, the laser source and the suction generating device so as to carry out a method, which may comprise the steps: a) arranging a plurality of first solder balls at a plurality of arranging positions of an arranging layout of the transporting tool by using the suction generating device, said arranging layout of the transporting tool corresponding to a contact pad layout of a substrate, said contact pad layout comprising a plurality of contact pads, b) placing the transporting tool opposite the substrate such that the plurality of first solder balls is associated with the plurality of contact pads, c) placing the plurality of first solder balls onto the plurality of contact pads, d) melting the plurality of first solder balls and releasing the plurality of first solder balls from the transporting tool to the plurality of contact pads by using the laser source so as to form a plurality of solder bumps on the plurality of contact pads, c) withdrawing the transporting tool from the substrate, f) arranging a plurality of second solder balls at the arranging positions of the arranging layout of the transporting tool by using the suction generating device, g) placing the transporting tool opposite the substrate such that the plurality of second solder balls is associated with the plurality of solder bumps, h) placing the plurality of second solder balls onto the plurality of solder bumps, i) melting the plurality of second solder balls and releasing the plurality of second solder balls from the transporting tool to the plurality of solder bumps by using the laser source so as to form a plurality of monolithic solder contact pins on the plurality of contact pads, and j) withdrawing the transporting tool from the substrate.

The transporting tool may comprise a plurality of passages having cross-sectional areas, which are smaller than those of the solder balls, wherein at one end of each passage there is an arranging position for a solder ball and the other end of the passage is connected to the suction generating device. The plurality of arranging positions form the arranging layout of the transporting tool. By generating a negative pressure in the passages by means of the suction generating device, the solder balls can be sucked in so as to be fixed to the passages at the arranging positions. By deactivating the suction generating device, the negative pressure is released and the solder balls can be placed on or released to contact pads or solder bumps on the substrate.

The arranging of the plurality of solder balls at the plurality of arranging positions of the arranging layout of the transporting tool in steps a) and f) may be carried out by picking up solder balls from a solder ball reservoir. Preferably, in order to pick up solder balls from the solder ball reservoir, the solder ball reservoir is exposed to ultrasound so as to achieve a statistically uniform distribution density of the solder balls in the reservoir on the one hand, and cause the solder balls to jump up in response to ultrasound oscillations on the other hand. Solder balls jumping against the transporting tool can be placed and held at the arranging positions e.g. by applying a negative pressure to the arranging positions.

Step d) melting of the plurality of first solder balls and releasing the plurality of first solder balls from the transporting tool to the plurality of contact pads by using the laser source so as to form a plurality of solder bumps on the plurality of contact pads can be carried out substantially simultaneously or in quick succession. Same considerations apply to step i) melting the plurality of second solder balls and releasing the plurality of second solder balls from the transporting tool to the plurality of solder bumps by using the laser source so as to form a plurality of monolithic solder contact pins on the plurality of contact pads. It is only important that after melting the first solder balls and releasing the first solder balls to the contact pads and after melting the second solder balls and releasing the second solder balls to the solder bumps substantially vertical monolithic solder contact pins are formed on the substrate.

The solder ball placing apparatus described above can be used to quickly and easily form a large number of solder contact pins on a substrate. Since the solder contact pins are formed from soldering material, there is no need to use conductive adhesives or additional soldering material, for example when electrical components, e.g. a chip, or another substrate are attached to the substrate. Thus, interface problems resulting from the use of different materials for a substrate, contact medium and contact pin material can be reduced.

The present disclosure discloses a controller for a solder ball placing apparatus comprising a transporting tool, a laser source, and a suction generating device, wherein the controller may be configured to control the transporting tool, the laser source and the suction generating device so as to carry out a method, which may comprise the steps: a) arranging a plurality of first solder balls at a plurality of arranging positions of an arranging layout of the transporting tool by using the suction generating device, said arranging layout of the transporting tool corresponding to a contact pad layout of a substrate, said contact pad layout comprising a plurality of contact pads, b) placing the transporting tool opposite the substrate such that the plurality of first solder balls is associated with the plurality of contact pads, c) placing the plurality of first solder balls onto the plurality of contact pads, d) melting the plurality of first solder balls and releasing the plurality of first solder balls from the transporting tool to the plurality of contact pads by using the laser source so as to form a plurality of solder bumps on the plurality of contact pads, e) withdrawing the transporting tool from the substrate, f) arranging a plurality of second solder balls at the arranging positions of the arranging layout of the transporting tool by using the suction generating device, g) placing the transporting tool opposite the substrate such that the plurality of second solder balls is associated with the plurality of solder bumps, h) placing the plurality of second solder balls onto the plurality of solder bumps, i) melting the plurality of second solder balls and releasing the plurality of second solder balls from the transporting tool to the plurality of solder bumps by using the laser source so as to form a plurality of monolithic solder contact pins on the plurality of contact pads, and j) withdrawing the transporting tool from the substrate.

The transporting tool may comprise a plurality of passages having cross-sectional areas, which are smaller than those of the solder balls, wherein at one end of each passage there is an arranging position for a solder ball and the other end of the passage is connected to the suction generating device. The plurality of arranging positions form the arranging layout of the transporting tool. By controlling the suction generating device by the controller so as to generate a negative pressure in the passages, the solder balls can be sucked in so as to be fixed to the passages at the arranging positions. By deactivating the suction generating device by the controller, the negative pressure is released and the solder balls can be placed on or released to contact pads or solder bumps on the substrate.

The arranging of the plurality of solder balls at the plurality of arranging positions of the arranging layout of the transporting tool in steps a) and f) may be carried out by picking up solder balls from a solder ball reservoir. Preferably, in order to pick up solder balls from the solder ball reservoir, the solder ball reservoir is exposed to ultrasound so as to achieve a statistically uniform distribution density of the solder balls in the reservoir on the one hand, and cause the solder balls to jump up in response to ultrasound oscillations on the other hand. Solder balls jumping against the transporting tool can be placed and held at the arranging positions e.g. by applying a negative pressure to the arranging positions.

Step d) melting of the plurality of first solder balls and releasing the plurality of first solder balls from the transporting tool to the plurality of contact pads by using the laser source so as to form a plurality of solder bumps on the plurality of contact pads can be carried out substantially simultaneously or in quick succession. Same considerations apply to step i) melting the plurality of second solder balls and releasing the plurality of second solder balls from the transporting tool to the plurality of solder bumps by using the laser source so as to form a plurality of monolithic solder contact pins on the plurality of contact pads. It is only important that after melting the first solder balls and releasing the first solder balls to the contact pads and after melting the second solder balls and releasing the second solder balls to the solder bumps substantially vertical monolithic solder contact pins are formed on the substrate.

The controller described above helps to quickly and easily form a large number of solder contact pins on a substrate. Since the solder contact pins are formed from soldering material, there is no need to use conductive adhesives or additional soldering material, for example when electrical components, e.g. a chip, or another substrate are attached to the substrate. Thus, interface problems resulting from the use of different materials for a substrate, contact medium and contact pin material can be reduced.

### BRIEF DESCRIPTION OF THE DRAWINGS

In the following, an embodiment of the present disclosure is described with reference to several figures:

FIG. 1 shows a front view of a solder ball placing apparatus forming solder contact pins on a contact pad layout of a substrate, said contact pad layout comprising a plurality of contact pads, according to an embodiment;

FIG. 2 shows another front view of the solder ball placing apparatus of FIG. 1, which applies solder balls to the contact pad layout of the substrate so as to form solder bumps on the plurality of contact pads;

FIG. 3 shows another front view of the solder ball placing apparatus of FIG. 1, which applies solder balls to the contact pad layout of the substrate at the time of contact of the solder balls and the contact pads;

FIG. 4 shows a front view of the solder ball placing apparatus of FIG. 2, which applies solder balls to the solder bumps present on the substrate;

FIG. 5 shows another front view of the solder ball placing apparatus of FIG. 2, which applies solder balls to the solder bumps present on the substrate; and

FIG. 6 shows a front view of solder contact pins formed on the substrate of FIG. 2.

The figures are merely schematic in nature and are intended solely for the purpose of understanding the disclosure. The proportions of the elements shown in the figures have been adjusted accordingly to make the disclosure easier to understand.

### DETAILED DESCRIPTION OF THE PREFERRED EMBODIMENTS

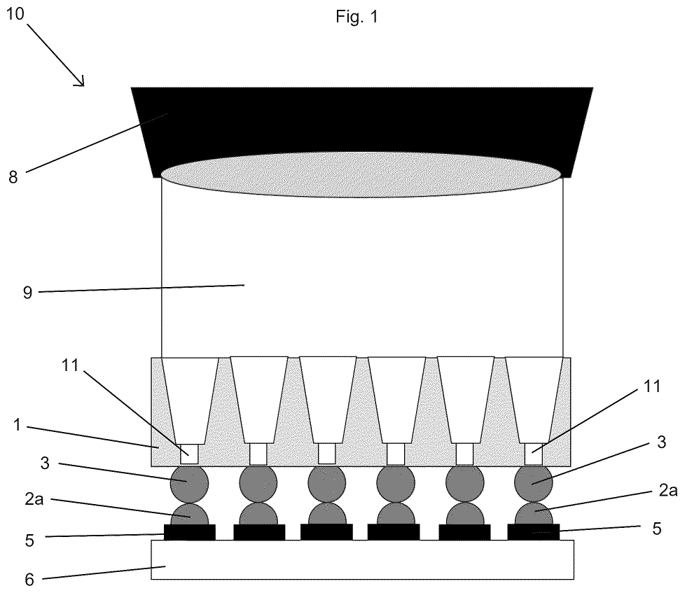

FIG. 1 discloses a solder ball placing apparatus 10 according to an embodiment comprising a movable transporting tool 1, a laser source 8, a suction generating device (not shown) and a controller (not shown) configured to control the transporting tool 1, the laser source 8 and the suction generating device.

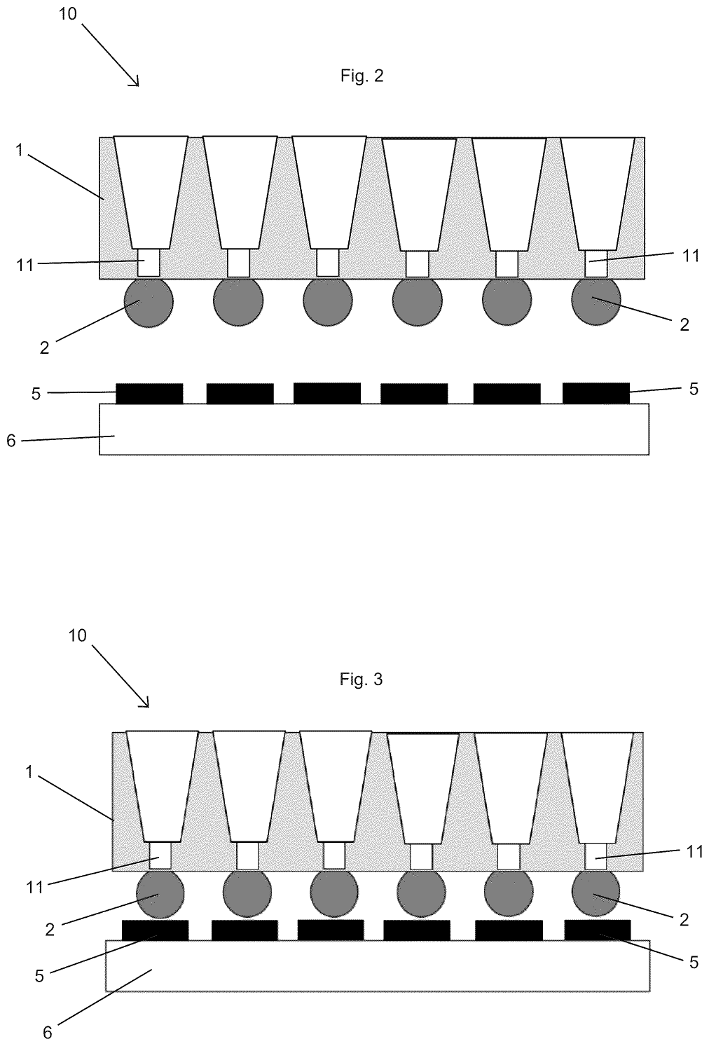

FIGS. 2 to 6 show the solder ball placing apparatus 10 carrying out several steps of a method of forming a plurality of solder contact pins 7 on a contact pad layout of a substrate 6.

Specifically, the transporting tool 1 comprises a plurality of passages 11 having cross-sectional areas, which are smaller than those of solder balls to be picked up by the transporting tool 1, wherein at one end of each passage 11 there is an arranging position for a solder ball and the other end of the passage 11 is connected to the suction generating device. The plurality of arranging positions form an arranging layout of the transporting tool 1. It is noted that FIGS. 1 to 5 each only exemplary discloses six passages 11 or six arranging positions of the arranging layout. However, the arranging layout may comprise more than six arranging positions, that is, the transporting tool 1 may comprise more than six passages 11 that can be arranged as required. By generating a negative pressure in the passages 11 by means of the suction generating device, the solder balls can be sucked in so as to be fixed to the passages 11 at the arranging positions.

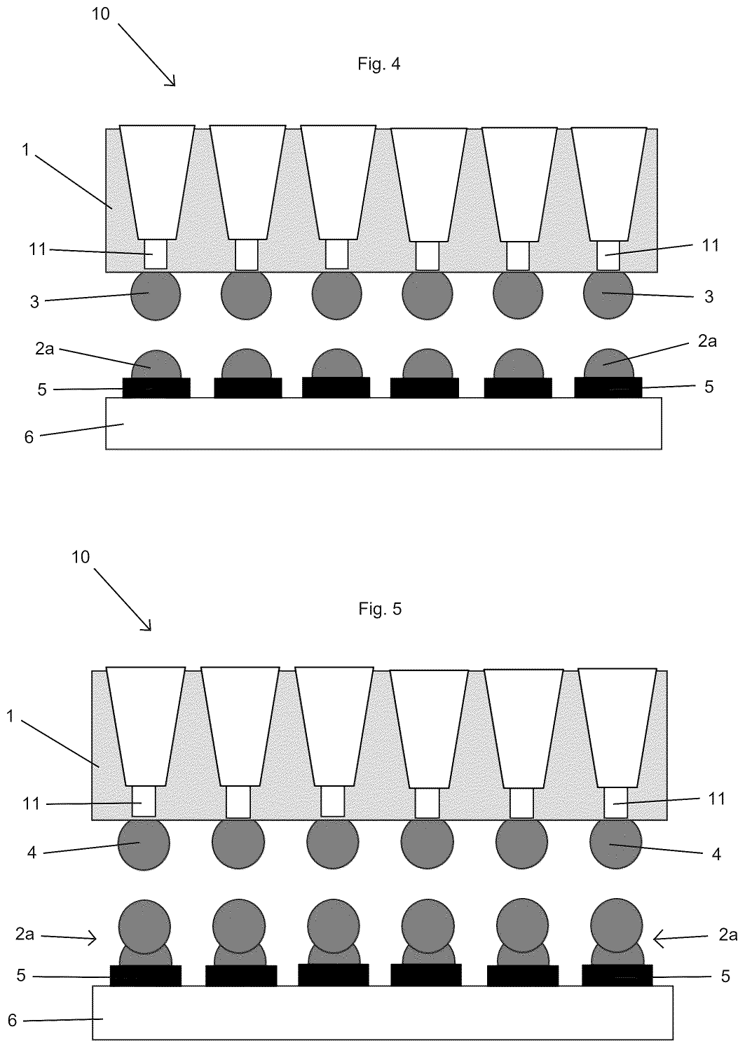

As shown in FIG. 2, first solder balls 2 have been picked up by the transporting tool 1 from a solder ball reservoir (not shown) and sucked in by the suction generating device so as to be fixed to the passages 11. Although not shown in the figures, it is checked whether all of the plurality of arranging positions of the arranging layout are covered with solder balls. Then, the transporting tool 1 is placed opposite the substrate 6 comprising a plurality of contact pads 5 being arranged in a contact pad layout corresponding to the arranging layout of the transporting tool 1. The plurality of first solder balls 2 is placed onto the plurality of contact pads 5, as shown in FIG. 3. Then, the laser source 8 is activated so that a laser beam 9 beaming through the passages 11 melts the plurality of first solder balls 2. By deactivating the suction generating device, the solder balls 2 are released to the plurality of contact pads 5 so as to form a plurality of solder bumps 2a (see FIG. 4) on the plurality of contact pads 5.

Subsequently, the transporting tool 1 is withdrawn from the substrate, and a plurality of second solder balls 3 are arranged at the arranging positions of the arranging layout of the transporting tool 1 by activating the suction generating device and picking up the second solder balls 3 from the solder ball reservoir. The transporting tool 1 is placed opposite the substrate 6 such that the plurality of second solder balls 3 is associated with the plurality of solder bumps 2a, as shown in FIG. 4. The plurality of second solder balls 3 is placed onto the plurality of solder bumps 2a. Then, the laser source 8 is activated so that the laser 9 beaming through the passages 11 melts the plurality of second solder balls 3. By deactivating the section generating device, the solder balls 3 are released to the plurality of solder bumps 2a.

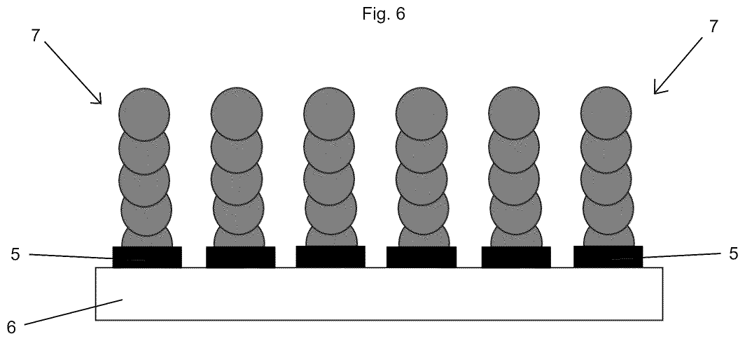

By repeatedly carrying out the above described steps and melting further solder balls 4 onto the plurality of solder bumps 2a, as shown in FIG. 5, monolithic solder contact pins 7 of any height can be formed on the substrate 6, as shown in FIG. 6.

The solder ball placing apparatus 10 and method described above can be used to quickly and easily form a large number of solder contact pins 7 on a substrate 6. Since the solder contact pins 7 are formed from soldering material, there is no need to use conductive adhesives or additional soldering material, for example when electrical components, e.g. a chip, or another substrate are attached to the substrate 6. Thus, interface problems resulting from the use of different materials for a substrate, contact medium and contact pin material can be reduced.

1. A method of forming a plurality of solder contact pins on a contact pad layout of a substrate, said contact pad layout comprising a plurality of contact pads, comprising the steps of:
a) arranging a plurality of first solder balls at a plurality of arranging positions of an arranging layout of a transporting tool, said arranging layout of the transporting tool corresponding to the contact pad layout of the substrate,
b) placing the transporting tool opposite the substrate such that the plurality of first solder balls is associated with the plurality of contact pads,
c) placing the plurality of first solder balls onto the plurality of contact pads,
d) melting the plurality of first solder balls and releasing the plurality of first solder balls from the transporting tool to the plurality of contact pads so as to form a plurality of solder bumps on the plurality of contact pads,
e) withdrawing the transporting tool from the substrate,
f) arranging a plurality of second solder balls at the arranging positions of the arranging layout of the transporting tool,
g) placing the transporting tool opposite the substrate such that the plurality of second solder balls is associated with the plurality of solder bumps,
h) placing the plurality of second solder balls onto the plurality of solder bumps,
i) melting the plurality of second solder balls and releasing the plurality of second solder balls from the transporting tool to the plurality of solder bumps so as to form a plurality of monolithic solder contact pins on the plurality of contact pads, and
j) withdrawing the transporting tool from the substrate.

2. The method according to claim 1, wherein steps f) to j) are repeatedly carried out to increase a height of the monolithic solder contact pins.

3. The method according to claim 2, wherein the plurality of solder balls placed last on the monolithic solder contact pins have a lower melting point than the solder balls placed beneath them.

4. The method according to claim 1, wherein between steps a) and b) and/or between steps f) and g) it is checked, in particular by pressure reading of a dynamic pressure at the arranging positions and/or by optically inspecting the arranging positions, whether all of the plurality of arranging positions of the arranging layout are covered with solder balls.

5. The method according to claim 1, wherein in step a) or f) the solder balls are arranged at the plurality of arranging positions of the arranging layout of the transporting tool by sucking.

6. The method according to claim 1, wherein in step d) or i) the solder balls are melted by applying laser energy onto them.

7. The method according to claim 1, comprising the step of measuring a height of the monolithic solder contact pins.

8. The method according to claim 7, wherein the measuring of the height of the monolithic solder contact pins is carried out optically and/or by force reading.

9. A solder ball placing apparatus comprising a transporting tool, a laser source, a suction generating device, and a controller configured to control the transporting tool, the laser source and the suction generating device so as to carry out a method comprising the steps:
a) arranging a plurality of first solder balls at a plurality of arranging positions of an arranging layout of the transporting tool by using the suction generating device, said arranging layout of the transporting tool corresponding to a contact pad layout of a substrate, said contact pad layout comprising a plurality of contact pads,
b) placing the transporting tool opposite the substrate such that the plurality of first solder balls is associated with the plurality of contact pads,
c) placing the plurality of first solder balls onto the plurality of contact pads,
d) melting the plurality of first solder balls and releasing the plurality of first solder balls from the transporting tool to the plurality of contact pads by using the laser source so as to form a plurality of solder bumps on the plurality of contact pads,
e) withdrawing the transporting tool from the substrate,
f) arranging a plurality of second solder balls at the arranging positions of the arranging layout of the transporting tool by using the suction generating device,
g) placing the transporting tool opposite the substrate such that the plurality of second solder balls is associated with the plurality of solder bumps,
h) placing the plurality of second solder balls onto the plurality of solder bumps,
i) melting the plurality of second solder balls and releasing the plurality of second solder balls from the transporting tool to the plurality of solder bumps by using the laser source so as to form a plurality of monolithic solder contact pins on the plurality of contact pads, and
j) withdrawing the transporting tool from the substrate.

10. A controller for a solder ball placing apparatus comprising a transporting tool, a laser source, and a suction generating device, wherein the controller is configured to control the transporting tool, the laser source and the suction generating device so as to carry out a method comprising the steps:
a) arranging a plurality of first solder balls at a plurality of arranging positions of an arranging layout of the transporting tool by using the suction generating device, said arranging layout of the transporting tool corresponding to a contact pad layout of a substrate, said contact pad layout comprising a plurality of contact pads,
b) placing the transporting tool opposite the substrate such that the plurality of first solder balls is associated with the plurality of contact pads,
c) placing the plurality of first solder balls onto the plurality of contact pads,
d) melting the plurality of first solder balls and releasing the plurality of first solder balls from the transporting tool to the plurality of contact pads by using the laser source so as to form a plurality of solder bumps on the plurality of contact pads,
e) withdrawing the transporting tool from the substrate,
f) arranging a plurality of second solder balls at the arranging positions of the arranging layout of the transporting tool by using the suction generating device,
g) placing the transporting tool opposite the substrate such that the plurality of second solder balls is associated with the plurality of solder bumps,
h) placing the plurality of second solder balls onto the plurality of solder bumps,
i) melting the plurality of second solder balls and releasing the plurality of second solder balls from the transporting tool to the plurality of solder bumps by using the laser source so as to form a plurality of monolithic solder contact pins on the plurality of contact pads, and
j) withdrawing the transporting tool from the substrate.
